(19) United States
(12) Patent Application Publication
(10) Pub. No.: US 2004/0133454 A1
(43) Pub. Date: Jul. 8, 2004

(54) Method for electronic consent form retrieval and entry

(76) Inventor: Terri A. Desio, Laredo, TX (US)

Correspondence Address: David Allen Hall, Jackson Walker, L.L.P., Suite 1100, 100 Congress Ave., Austin, TX, 78701, US

(21) Appl. No.: 10/740,289

(22) Filed: Dec. 18, 2003

Related U.S. Application Data
(60) Provisional application No. 60/434,581, filed on Dec. 18, 2002.

(51) Int. Cl. G06F 17/60

(52) U.S. Cl. 705/2

(57) ABSTRACT

A method for incorporating an initiation form into a business process. Forms, the completion and signing of which are required for subsequent steps in the flow of a business process, are digitally stored in a central server system where they are categorized, cross-referenced; modified, updated, and archived. They can also be disseminated, over communication networks, to remote client systems in response to requests from users. Users at the client computers can annotate and sign the forms without the burden of periodically purging hard-copy storage of outdated forms. Users can make paper copies or electronically sign the forms and upload them to the central server for storage.

### PRIORITY

This application claims priority from provisional application No. 60/434,581 filed Dec. 18, 2002.

### FIELD OF THE INVENTION

The present invention relates generally to a computerized business method that facilitates administration and record keeping in any field in which consent, pre-approval, authorization, or any other initiation step is mandatory prior to commencement of subsequent steps.

More specifically, the present invention relates to a business method in which the initiation step is manifested as a medical consent form managed by a system utilizing a centralized library of consent forms, all of which can be accessed, annotated, printed, and signed at locations remote from the library. The present invention permits the consent forms to be annotated, signed, and stored physically in hard copy format or electronically in digital format.

### BACKGROUND OF THE INVENTION

There are many governmental, educational, administrative, medical, and business processes that begin with, and only with, the signing of one or more preliminary agreement documents (initiation forms) that specify terms and conditions of the agreement. Employees, officers, and agents who must explain such initiation forms and submit them to clients and customers for signature are generally responsible for viability and accuracy of the forms, as well as for assurance of client comprehension.

More specifically, medical protocol and legal liability necessitate the use of patient or guardian consent forms in conjunction with most medical procedures. Such forms include, but are not limited to a description, sometimes in the written words of the patient, of the medical procedure to be performed, the reason for performing the procedure, indication of the exact area of the body upon which the procedure will be performed, identification of the person who will perform the procedure, and a statement of the possible risks associated with the procedure. Medical consent is the act of agreeing to a specific diagnostic test or treatment, and is typically documented in the medical record by means of a consent form. By signing the form, the patient authorizes the named practitioner to perform the named procedure, and the patient accepts the named risks.

There are hundreds of medical procedures, most of which require unique consent forms. Some procedures may require more than one consent form. For instance, a surgical procedure might call for one form for each surgeon, one for the anesthesiologist, and another for a nurse anesthetist. Medical science progress begets modified or new procedures that require modified or new consent forms. Medical practitioners and care-givers who must explain consent forms and submit them to patients and guardians for signature have the grave responsibility of assuring that the forms are current, match the relevant procedures, and are written in a language and with a level of sophistication that the patient can understand.

A centralized repository of consent forms in hard copy format is susceptible to misfiling, insufficient replenishment, loss, fire and water damage, and obsolescence. Those problems are exacerbated by the maintenance of multiple hard copy repositories in remote locations and the necessity of providing forms in various languages.

A malfunctioning system of medical consent form delivery, signature, recordation, and storage presents a high potential for liability. Patients can lose faith in medical practitioners who are unable to confidently and timely submit and explain required consent forms. Health care can be delayed if the proper consent forms are not available where and when needed. Medical practitioners may hesitate to use a consent form if its viability is questionable. And physicians and nurses realize fully that the outcome of any legal question about a medical procedure may depend on the viability and proper submission of consent forms that may have been signed years before the question arose.

### SUMMARY OF THE INVENTION

The present invention provides a solution to the foregoing problems in the form of a method that permits storage in, and access to, centralized digital libraries of unannotated initiation forms and annotated and signed initiation forms that can be retrieved by electronically searching various fields including, but not limited to, language preference, form originator, agreement type and subject, client name, and date and location of the agreement's subject procedure. Responsibility for expanding and updating the collection of forms resides with librarians or curators who provide periodic, timely oversight with, if needed, approval from legal counsel, chiefs of staff, department heads, directors, or whomever holds ultimate supervisory authority. More specifically, in the case of medical consent forms, the librarian may be required to obtain and record approval for modification of a form from, for instance, a hospital chief of staff, risk management counsel, or both.

The present invention gives medical practitioners confidence that their digital initiation forms are current, viable, and available at the time of need. The present invention also provides for digital storage of signed initiation forms in a safe environment from which they may be retrieved years in the future if needed by, for example, a physician, an insurance carrier, a hospital, or a court of law.

The present invention relieves an employee, physician, nurse, officer, or agent (hereinafter collectively referred to as a “Facilitator”) of an entity including, but not limited to, a corporation, governmental unit, retail outlet, or hospital of the burden of storing large quantities of hard copy initiation forms that can be misplaced, destroyed, or rendered obsolete by changing conditions. More specifically, the present invention relieves health care practitioners of the burden of storing large quantities of hard copy consent forms that can be misplaced, destroyed, or rendered obsolete by advances in medical science.

### BRIEF DESCRIPTION OF THE DRAWINGS

FIG. 1 is a flow diagram of the preferred embodiment of the present invention.

FIG. 2 is a schematic of the present invention depicting a central server system and several client systems interconnected by Intranet or Internet communication channels.

FIG. 2 also illustrates hardware that can be connected to the typical client computer. Such hardware includes, but is not limited to, text entry devices, printers, scanners, and optical character recognition devices.

### DETAILED DESCRIPTION OF THE PREFERRED EMBODIMENT

Using the system of the present invention, a Facilitator of a medical institution logs onto a computer while meeting with a patient client. Coincidentally, computers at locations remote from a central server location are generally called client computers, not because they are located where interface with human clients typically occurs (although they may be), but because they are “clients” of a server system.

The Facilitator downloads, from a server system, a consent form for the desired procedure in the appropriate language and explains its contents to the patient. The form may be printed, or its image may be viewed on the monitor of the Facilitator's computer. The Facilitator and patient can annotate and sign the printed form, in which case the form can subsequently be scanned, uploaded into a central library maintained by the server system, and appropriately disseminated, or the signed form can be stored and other paper copies can be disseminated.

Consent forms that can be included in the central library of the present invention include, but are not limited to, Do Not Resuscitate (DNR), Medical Power of Attorney, and Living Will. The central library may also include consent forms for procedures such as, among others, use of restraints, diagnostic testing, anesthesia administration, angioplasty, colonoscopy, nephrectomy, osteotomy, circumcision, hysterectomy, radiation therapy, radiology, chemotherapy administration, HIV testing, blood transfusion, various vaccinations, hearing examinations, neonatal intensive care, and autopsy.

The server of the present invention is capable of using commonly understood sorting algorithms to sort stored forms according to any of several data fields. Such data fields can be identified with such words as Obstetrics, Anesthesiology, and Radiology, or the data can be stored according to, for example, the names of individual doctors or the names of particular procedures such as Beir block, Cesarean Delivery, and Autopsy.

It is technologically feasible for the digital image of an initiation form to be electronically annotated and signed. That technology eliminates need for the printing and scanning steps of the present invention. Voice recognition technology may also be used with the present invention to permit completion of an initiation form in a more interactive manner by, for instance, visually impaired Facilitators and clients.

According to the business protocol of a particular entity, receipt of a signed initiation form by a server system maintaining a central library may trigger subsequent facets of a multi-faceted process. Initiation form receipt may be a prerequisite and notification for, for example, release of funds, letting of contracts, or reservation of a surgical theater. Such functions are routinely performed by algorithms containing, for example, commonly understood branching and “if-then” commands.

In response to changes in procedures, Facilitators can initiate consent form changes and request inclusion of new forms in the central digital library simply by notifying the responsible librarian. The librarian can then promulgate the changed and new forms throughout the entire medical practice area served by the library without the wasteful, time consuming, and error-prone task of purging hard copy files. And librarians, if so authorized, can update forms without Facilitator input.

The present invention permits the librarian to archive an outdated form in digital format in the event that, sometime after a change, questions arise about prior forms. Forms can be annotated with version and date identifiers that would enable a Facilitator using a new form and a researcher examining an old form to verify vintage.

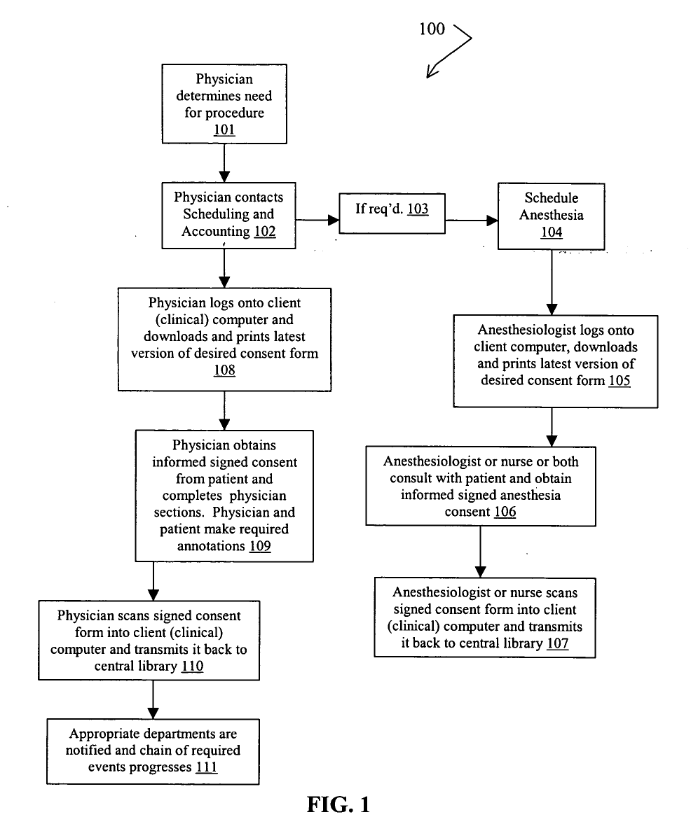

FIG. 1 illustrates one embodiment of the method 100 of the present invention, specifically the method of using the present consent form system for a procedure that requires anesthesia. After a Facilitator (here, a physician) determines, subsequent to a diagnostic process 101, that a particular medical procedure is necessary, he or she or an assistant notifies a Scheduling department and an Accounting department with any form of notification 102 preferred by the particular medical institution. The Facilitator also notifies the Anesthesiology department with any form of notification 103 preferred by the particular medical institution. If necessary, other practitioners and departments could be notified in the same manner.

After notification by the Facilitator, the Anesthesiology department begins its preferred scheduling process 104. As part of that process, an Anesthesiologist, Anesthetist Nurse Practitioner, or an authorized assistant logs (105) onto a client computer (sometimes referred to in the medical profession as a clinical computer) and requests the appropriate form, perhaps, but not necessarily, in the presence of the patient. If the requestor's name or password is found on a table look-up or authorized access list by a preprogrammed software algorithm, the request is processed, the form is sent from the central server system to the client computer where it is printed. After verifying the form's applicability, language, and vintage, the anesthesiology practitioner and patient will normally discuss it. The anesthesiology practitioner and patient make annotations if required, and sign (106) the consent form. The anesthesiology practitioner or an assistant then scans the completed form, or forms, into the client computer and uploads the annotated and signed images into the central library server system for storage and appropriate dissemination (107). The anesthesiology practitioner may keep hard copies of the completed form and disseminate copies to others, including the patient.

In the disclosed embodiment of the present invention, the Facilitator, after notifying the Scheduling and Accounting departments, and any other required practitioners, logs (108) onto a client computer and requests the appropriate form, perhaps, but not necessarily, in the presence of the patient. If the Facilitator's name or password is found on a table look-up or authorized access list by a preprogrammed software algorithm, the request is processed, the form is sent from the central server system to the client computer where it is printed. After verifying the form's applicability, language, and vintage, the Facilitator and patient will normally discuss it. The Facilitator and patient make annotations if required, and sign (109) the consent form. The Facilitator or an assistant then scans the completed form, or forms, into the client computer and uploads the annotated and signed images into the central library server system for storage and appropriate dissemination (110). The Facilitator may keep hard copies of the completed form and disseminate copies to others, including the patient.

Recordation of the required, signed consent form by the Facilitator sets a flag in an algorithm 111 of the central server system, enabling notification of any other departments whose participation in the particular medical procedure at issue is required.

Voice recognition and electronic signature technology offer variations of the described preferred embodiment that decrease or eliminate the need for printing and scanning at the site where the practitioner and patient discuss the consent forms. Voice activated interactive completion of consent forms may prove to be more efficient than more traditional means. And, where legally feasible, the digital image of a consent form may be electronically annotated and signed.

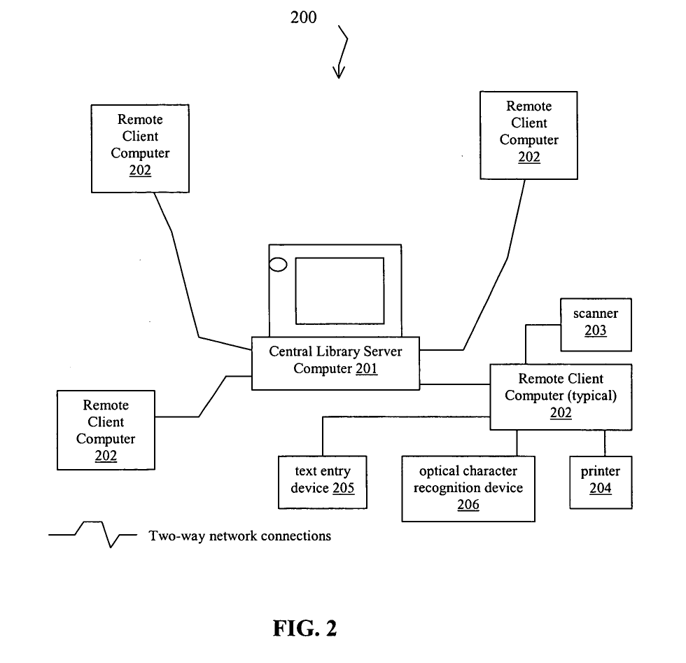

FIG. 2 is a schematic of one embodiment 200 of the hardware required to practice the present invention. A plurality of remote client computer systems 202 communicate with a central library server system 201 over an Internet or Intranet system, or a combination of both. The communication means can be dial-up, wireless, satellite, or any other network communication technology feasible now or in the future. Each client computer system central processing unit can be in direct or remote communication with various peripheral devices including, but not limited to, text entry keyboards, touch screens, optical readers, scanners, or printers (203, 204, 205, and 206). The central system 201 includes, but is not limited to, a central processing unit, a power supply unit, a data storage unit, network connections, data entry devices, and a monitor, all of which are generally available and commonly understood.

While the present invention has been described in terms of a preferred embodiment, it will be apparent to those skilled in the art that form and detail modifications may be made to that embodiment without departing from its spirit or scope.

I claim:

1. A method of incorporating an initiation form into a business procedure, said method comprising:
under control of a server system,
searching, categorizing, editing, annotating, deleting, receiving, sending, storing, and otherwise manipulating said form;
reviewing a request for a blank version of said form sent over an electronic communication network by a client system;
making a first determination whether said request for said blank form meets predetermined authorization criteria;
based on said first determination, granting or denying said request for said blank form;
receiving a modified, edited, annotated, signed, or otherwise completed version of said blank form from said client system, said completed version of said blank form having been completed by a user of said client system;
making a second determination whether said completed version of said blank form requires subsequent action;
based on said second determination, performing said required subsequent actions; and
under control of said client system,
displaying information identifying said business procedure;
sending an identifier of said user of said client system to said server system;
sending a request for a said blank form to said server system;
modifying, editing, annotating, signing, or otherwise completing said blank form; and
sending said completed version of said blank form to said server system, said server system being in two-way communication with one or more remotely located said client systems over an Intranet or Internet network, said client systems being capable of communicating with each other through said server system, and being capable of communicating with peripheral devices capable of data entry, display, and manipulation.

2. The method of claim 1 wherein said client systems are capable of interactive touch screen data entry.

3. The method of claim 1 wherein said client systems are capable of interactive speech recognition.

4. The method of claim 1 wherein all functions of said client system can be performed by said server system.

5. The method of claim 1 wherein said initiation form is a medical consent form.

6. A method of incorporating a consent form into a process of conducting a medical procedure, said method comprising:
under control of a server system,
searching, categorizing, editing, annotating, deleting, receiving, sending, storing, and otherwise manipulating said form;
reviewing a request for a blank version of said form sent over an electronic communication network by a client system;
making a first determination whether said request for said blank form meets predetermined authorization criteria;
based on said first determination, granting or denying said request for said blank form;
receiving a modified, edited, annotated, signed, or otherwise completed version of said form from said client system, said completed version of said blank form having been completed by a user of said client system;
making a second determination whether said completed version of said form requires subsequent action;
based on said second determination, performing said required subsequent actions; and
under control of said client system,
displaying information identifying said medical procedure;
sending an identifier of said user of said client system to said server system;
sending a request for a said blank form to said server system;
modifying, editing, annotating, signing, or otherwise completing said blank form; and
sending said completed version of said blank form to said server system, said server system being in two-way communication with one or more remotely located said client systems over an Intranet or Internet network, said client systems being capable of communicating with each other through said server system, and being capable of communicating with peripheral devices capable of data entry, display, and manipulation.

7. The method of claim 6 wherein said client systems are capable of interactive touch screen data entry.

8. The method of claim 6 wherein said client systems are capable of interactive speech recognition.

9. The method of claim 6 wherein all functions of said client system can be performed by said server system.
